(19) United States
(12) Patent Application Publication
(10) Pub. No.: US 2022/0245477 A1
(43) Pub. Date: Aug. 4, 2022

(54) SELECTING CONDITIONALLY INDEPENDENT INPUT SIGNALS FOR UNSUPERVISED CLASSIFIER TRAINING

(71) Applicant: Box, Inc., Redwood City, CA (US)

(72) Inventors: Kave Eshghi, Los Altos, CA (US); Victor De Vansa Vikramaratne, Sunnyvale, CA (US)

(73) Assignee: Box, Inc., Redwood City, CA (US)

(21) Appl. No.: 17/163,243

(22) Filed: Jan. 29, 2021

(51) Int. Cl. G06N 5/04; G06N 20/00; G06F 21/62

(52) U.S. Cl. CPC G06N 5/04; G06F 21/6245; G06N 20/00

(57) ABSTRACT

Methods, systems, and computer program products for content management systems. An unlabeled dataset comprising documents that at least potentially comprise personally identifiable information (PII) is used when training a PII content classifier. Such a classifier is trained by (1) determining, based on applying a PII rule to a first portion of a document selected from the unlabeled dataset, a confidence value that the first portion of the document does contain personally identifiable information, (2) selecting a second portion of the document selected from the unlabeled dataset such that the second portion does not include the first portion; and (3) assigning, based on the confidence value, a likelihood value that corresponds to whether characteristics of the second portion are indicative that the document does contain personally identifiable information. Such a PII content classifier is used over selected portions of subject content objects to determine whether the selected portions contain PII.

### RELATED APPLICATIONS

The present application is related to co-pending U.S. patent application Ser. No. 17/163,222, titled “PRIORITIZING OPERATIONS OVER CONTENT OBJECTS OF A CONTENT MANAGEMENT SYSTEM”, filed on Jan. 29, 2021, which is hereby incorporated by reference in its entirety.

### TECHNICAL FIELD

This disclosure relates to content management systems, and more particularly to techniques for selecting conditionally independent input signals for use in unsupervised classifier training.

### BACKGROUND

Cloud-based content management services and systems have impacted the way personal and enterprise computer-readable content objects (e.g., files, documents, spreadsheets, images, programming code files, etc.) are stored, and has also impacted the way such personal and enterprise content objects are shared and managed. Content management systems provide the ability to securely share large volumes of content objects among trusted users (e.g., collaborators) on a variety of user devices, such as mobile phones, tablets, laptop computers, desktop computers, and/or other devices. Modern content management systems can host many thousands or, in some cases, millions of files for a particular enterprise that are shared by hundreds or thousands of users.

While the ability to share content objects among hundreds or thousands of users has been a boon to effective collaboration, it also means that often, personally identifiable information (PII) is shared, which in turn opens up the possibility that PII can fall into the hands of malefactors. As the likelihood and risks of malevolent use of PII increase more and more, so are user demands for more control of their PII.

In recent times, various institutions (e.g., governments, enterprises, universities, etc.) have enacted rules and regulations that are intended to give users more control over their PII. For example, in some jurisdictions, a user may request a holder of the user's PII (e.g., a bank, a broker, a store, etc.) to remove the requesting user's PII from their electronic files. In some cases, all of a user's PII is contained in a user profile record in a one-to-one fashion, and the deletion of the user's profile record serves to remove the user's PII from the holder's electronic files. However, in some usage scenarios (e.g., within a content management system), a particular user's PII may be distributed across many files, which may or may not be one-to-one linked to the requesting user. In such a usage scenario, the existence of PII in a document needs to be identified, regardless of the form of the contents of the document.

To aid in identification of PII in a document, a labeled dataset can be used in a classifier, however a labeled dataset is not always available in the context of content management systems. To aid in labeling occurrences of PII in a document, a ruleset can be used. For example, a PII detection rule (e.g., a regular expression rule) can be devised to label the occurrence of a phone number when the phone number is formatted as “123-456-7890”. In some rule implementations, a rule can be devised to label the occurrence of a phone number even when the phone number is formatted as “(123) 456-7890”, or “(123)4567890”, or even “1234567890”, however this often leads to false positives when the labeling and training the classifier, which in turn leads to false positives when inferencing using the classifier. A rule can be made to be more restrictive, however this often leads to false negatives (e.g., missed hits).

Unfortunately, since the input data in a content management system is not labeled with respect to PII, and since neither tightening a rule nor relaxing a rule achieves the desired high precision when labeling and training a classifier, some means needs to be devised that does achieve the desired high precision when labeling and training a classifier. What is needed is a technique or techniques that address improving precision and recall of a PII classifier.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for selecting conditionally independent input signals for unsupervised classifier training, which techniques advance the relevant technologies to address technological issues with legacy approaches. More specifically, the present disclosure describes techniques used in systems, methods, and in computer program products for improving classifier precision and recall using conditionally independent input signals taken from mutually-exclusive document content selections.

The disclosed embodiments modify and improve over legacy approaches. In particular, the herein-disclosed techniques provide technical solutions that address the technical problems attendant to improving precision and recall of a PII classifier. Such technical solutions involve specific implementations (i.e., data organization, data communication paths, module-to-module interrelationships, etc.) that relate to the software arts for improving computer functionality.

The ordered combination of steps of the embodiments serve in the context of practical applications that perform steps for co-training a classifier using selected conditionally independent sets of input signals. These techniques for co-training a classifier using selected conditionally independent sets of input signals overcome long standing yet heretofore unsolved technological problems associated with improving precision and recall of classifiers, which technological problems arise in the realm of computer systems.

Many of the herein-disclosed embodiments for co-training a classifier using selected conditionally independent sets of input signals are technological solutions pertaining to technological problems that arise in the hardware and software arts that underlie machine learning classifiers. Aspects of the present disclosure achieve performance and other improvements in peripheral technical fields including, but not limited to, machine learning and data governance.

Some embodiments include a sequence of instructions that are stored on a non-transitory computer readable medium. Such a sequence of instructions, when stored in memory and executed by one or more processors, causes the one or more processors to perform a set of acts for co-training a classifier using selected conditionally independent sets of input signals.

Some embodiments include the aforementioned sequence of instructions that are stored in a memory, which memory is interfaced to one or more processors such that the one or more processors can execute the sequence of instructions to cause the one or more processors to implement acts for co-training a classifier using selected conditionally independent sets of input signals.

In various embodiments, any combinations of any of the above can be combined to perform any variations of acts for improving classifier precision and recall using conditionally independent input signals, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A exemplifies a classifier co-training technique as used for improving PII classifier precision and recall using conditionally independent input signals, according to an embodiment.

FIG. 1B exemplifies an inferencing technique as used in conjunction with a co-trained PII classifier, according to an embodiment.

FIG. 1C shows a document that is subjected an example PII rule to produce PII rule results, according to an embodiment.

FIG. 2 is a dataflow diagram showing a system for determining whether a document contains PII, according to an embodiment.

FIG. 3 is a dataflow diagram showing an unsupervised training data ingestion technique as used in systems that improve classifier precision and recall by using conditionally independent input signals, according to an embodiment.

FIG. 4 is a dataflow diagram showing a weight adjustment technique using back propagation to improve PII classifier precision and recall by using conditionally independent input signals, according to an embodiment.

FIG. 5 shows an example content management system environment in which aspects of a PII classifier and a PII inferencer can be implemented.

FIG. 6 depict system components as arrangements of computing modules that are interconnected so as to implement certain of the herein-disclosed embodiments.

FIG. 7A and FIG. 7B present block diagrams of computer system architectures having components suitable for implementing embodiments of the present disclosure and/or for use in the herein-described environments.

### DETAILED DESCRIPTION

Aspects of the present disclosure solve problems associated with using computer systems for improving precision and recall of a PII classifier. Some of the embodiments are particular to computer-implemented deployment of PII classifiers in the context of content management systems. Some embodiments are directed to approaches for selecting conditionally independent sets of input signals. The accompanying figures and discussions herein present example environments, systems, methods, and computer program products for improving classifier precision and recall using conditionally independent input signals.

### Overview

Disclosed herein are techniques to co-train a classifier using mutually-exclusive portions of a document. The co-trained classifier is then used to determine whether or not a particular portion of a document (e.g., text passage, spreadsheet cell, etc.) contains PII. As disclosed in detail hereunder, a classifier is trained using the context of portions of a document wherever a rule predicts the occurrence of PII in the portion. In some cases, the rule may not only identify (i.e., predict) the occurrence of PII and its location in the document, but it may also predict that the PII corresponds to a particular type of PII (e.g., an “infotype”).

In absence of a labeled dataset that could be used to train a classifier, an unsupervised learning approach is applied. More specifically, a rulebase is applied to portions of a document, and rule results (e.g., indications of a “hit” from application of the rule) are used to label the document or portions thereof. The thusly-labeled portions of the document are used in conjunction with classifier training signals that arise from processing the context of the thusly-labeled portions of the document. When the classifier input signals that correspond to indications of a “hit” (e.g., based on application of the rules) are conditionally independent from the classifier training signals that arise from the mutually-exclusive context, then the precision and recall of the classifier is improved (e.g., as compared to the precision and recall of a classifier that is trained using only the rulebase).

The embodiments discussed hereunder take advantage of the foregoing conditional independence so as to train a classifier using an unlabeled dataset and a rulebase. More specifically, at the time of training, the classifier is co-trained (1) by using probable-PII labels, probable-PII infotype designation, probable-PII locations, etc. that are determined upon application of a rule, and (2) by using the context surrounding the probable-PII locations.

As used herein, an infotype designation is a designation of a particular type of information that is considered to at least potentially correspond to personally identifiable information.

The trained classifier can be used to make inferences that apply to an incoming document. In some embodiments, at inference time, the output of the classifier is combined with outputs of the rulebase, which further improves accuracy as to whether or not a particular portion of a document contains PII. As such, when an inferencer combines output of the co-trained classifier with outputs of the rulebase, the determination of existence of probable-PII within a particular portion of a document is greatly improved such that additional processing can be carried out over the probable-PII and/or over the particular portion of the document and/or over the incoming document.

### Conditional Independence

In the foregoing discussion, it is emphasized that rules and context are combined—both during unsupervised training of a classifier and during inferencing. The fact that the probabilities that arise from application of the rules are independent from the probabilities that arise from consideration of the context around the probable PII leads to higher performance of inferencing. As such, the disclosed embodiments rely on ensuring that the inputs to the rules are independent from the context selected around the probable PII identified by the rules.

### Mathematical Treatment of Conditional Independence?

Let R, C, G be three binary random variables that can take values 0 and 1 (Bernoulli variables), then: R and C are conditionally independent given G if, and only if:

E(R*C|G=0)=E(R|G=0)*E(C|G=0) and

E(R*C|G=1)=E(R|G=1)*E(C|G=1)

Intuitively, conditional independence means that if we know the value of G, then R and C become independent; that is, their values are uncorrelated. However, if we don't know the value of G, then R and C only might be correlated.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

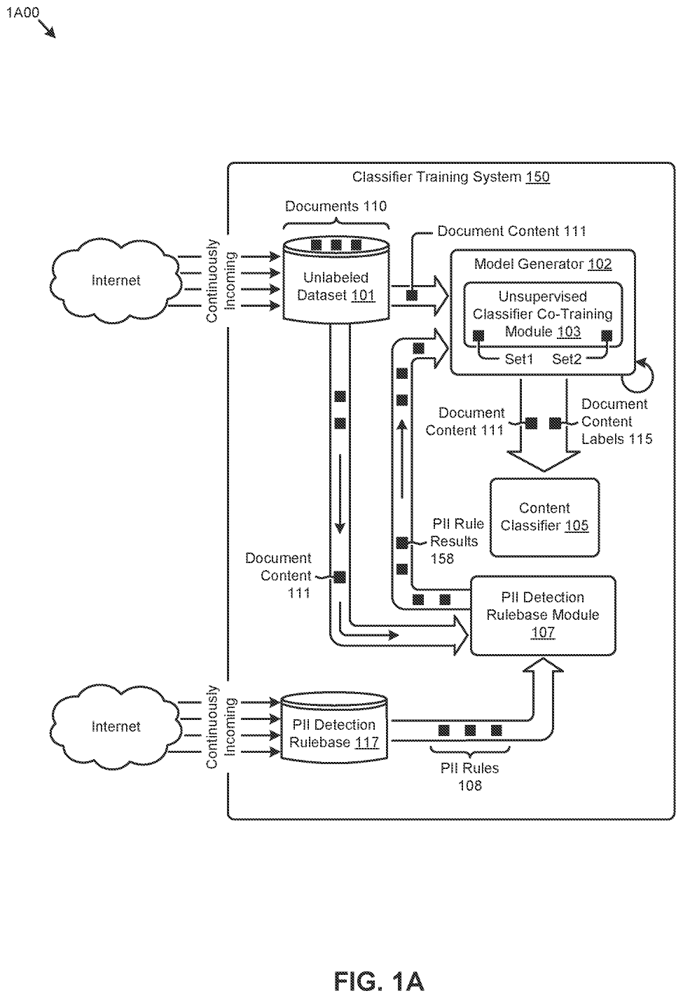

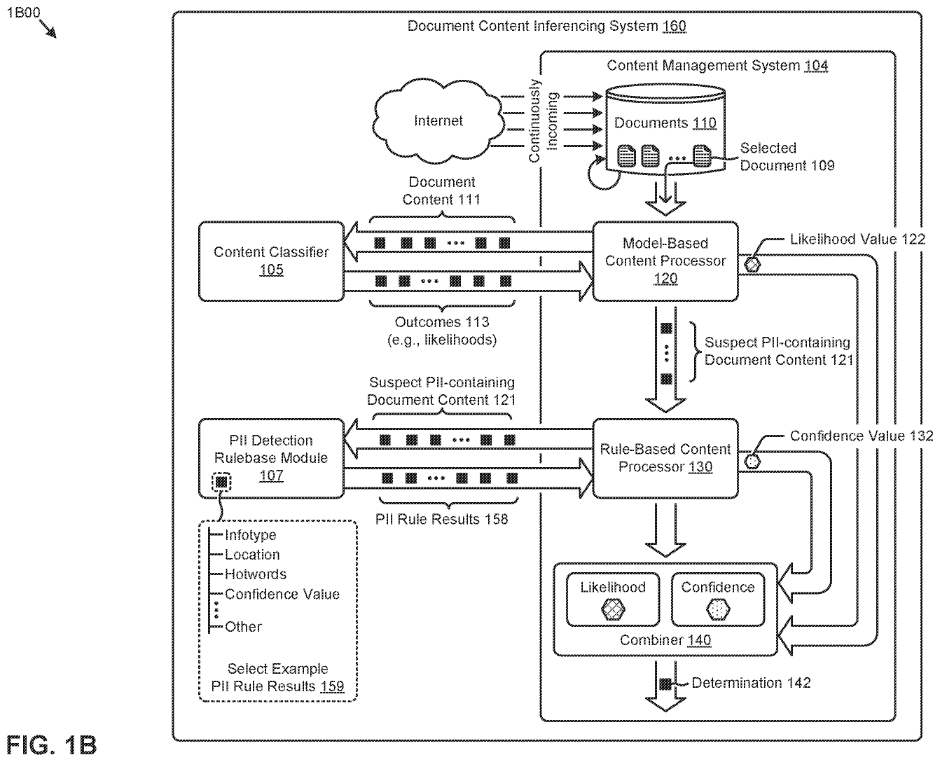

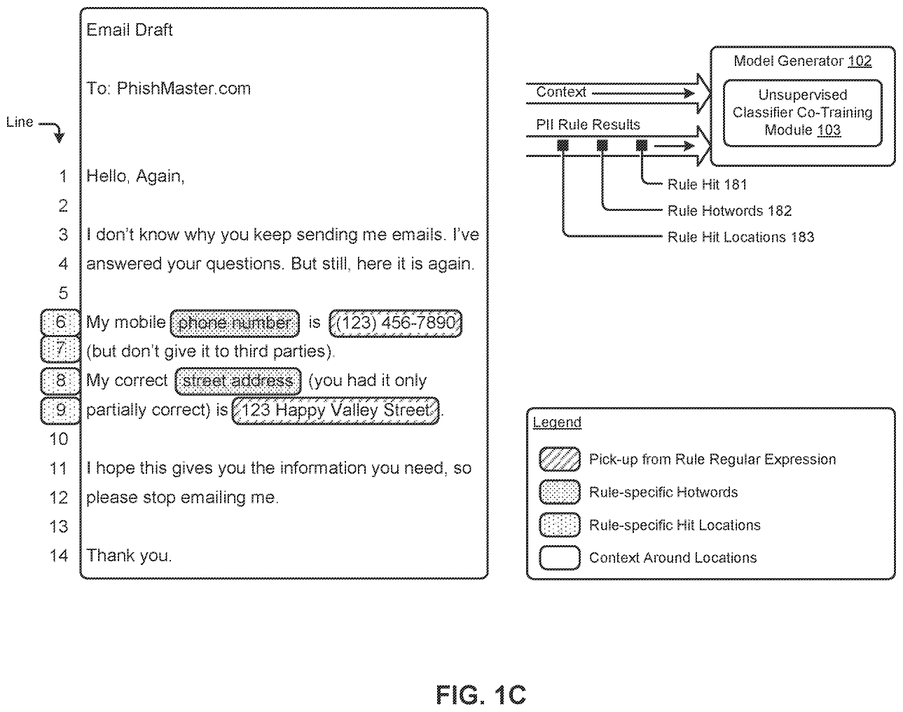

FIG. 1A exemplifies a classifier co-training technique 1A00 as used for improving PII classifier precision and recall using conditionally independent input signals. As an option, one or more variations of classifier co-training technique 1A00 or any aspect thereof may be implemented in the context of the architecture and functionality of the embodiments described herein and/or in any in any environment.

The figure is being presented to show how a content classifier 105 can be co-trained using two conditionally independent set of inputs: (1) document content 111 taken from an unlabeled dataset 101 of documents 110 and, (2) PII rule results 158 that arise from applying rules taken from a PII detection rulebase 117 over the document. As shown, the unlabeled dataset is continuously updated (e.g., by input of continuously-incoming data from the Internet). Also, the PII detection rulebase is continuously updated, possibly based on inputs from the Internet.

The contents of these two corpora serve as two sets of conditionally independent inputs that are ingested by a model generator 102, which model generator includes an unsupervised classifier co-training module 103 that is configured to co-train a classifier using the aforementioned two sets (e.g., set1 and set2) of conditionally independent inputs. As shown, the model generator 102 ingests document content and PII rule results. The documents content is processed into nonoverlapping portions, where a first portion (e.g., set1) includes the string or strings that are used by a particular rule, and where second, third and other portions (e.g., set2, etc.) include context that is found proximal to or associated with the first portion.

In the unsupervised learning example depicted by classifier training system 150, the outputs of the model generator include document content 111 with corresponding labels. As shown, the document content 111 and corresponding document content labels 115 are emitted as pairs, and are stored by the content classifier 105. Strictly as one example, if a certain portion of the document content contains the string “Area Code (408) 555-1212”, then that portion of the document might be labeled with a high confidence that that portion of the document contains a phone number by virtue of the document content containing “hot words” (e.g., “Area Code”) in the string. Continuing the same example, the document content that contains the string “Area Code (408) 555-1212” might have some context around it, such as the string, “My telephone number is”. The entire document content portion, and/or the specific context string “My telephone number is”, might be labeled with a high likelihood that the document content portion contains PII.

Aspects of the foregoing unsupervised learning example rely, at least in part, on availability of conditionally independent set of inputs going into model generator 102. The shown PII rule results 158 forms one set of inputs while the document content form a second set of inputs. In exemplary cases, these two sets of inputs are conditionally independent. As shown, the foregoing two sets of inputs can be formed within unsupervised classifier co-training module 103. Specifically, the shown set1 may comprise just the string identified by a rule, whereas set2 may comprise portions of the document that are found proximal to or associated with the string identified by the rule.

Any number of PII rules 108 may be applied to document content, and any number of PII rules 108 may be drawn from a PII detection rulebase 117 that in turn is continuously updated with continuously incoming PII detection rules. Moreover, a PII detection rulebase module 107 may be deployed so as to (1) continuously receive continuously-incoming instances of PII rules 108, (2) continuously receive continuously-incoming instances of document content 111, and (3) provide PII rule results 158 to unsupervised classifier co-training module 103.

Document content may be bounded using any known technique. For example, document content can be bounded in correspondence to a paragraph of a text-oriented document, and/or document content can be bounded in correspondence to a sentence of a text-oriented document. In some cases, document content can be bounded in correspondence to a number of words or ngrams (e.g., words and/or separators). In some situations, a subject document might be a spreadsheet and/or might be tabularly-oriented such that document content might include data from column header cells, and/or data from row label cells. In some cases, a single document might include a combination of text-oriented content and tabularly-oriented content. In such cases, the document can be divided into a number of text-oriented portions and a number of tabularly-oriented portions. In some situations, a document might serve as a form, in which case it can happen that a form field name can be used as document content or context. It can also happen that a form field value can be used as document content or context.

Any one or more variations of content classifiers (e.g., pertaining to different infotypes) that are continuously co-trained as heretofore discussed can be situated to operate within a content management system. Such a content management system can avail itself of the high precision and recall of the foregoing content classifier(s) so as to confidently infer as to whether or not a particular portion of a document of the content management system contains PII. One technique for document content inferencing is shown and described as pertains to FIG. 1B.

FIG. 1B exemplifies an inferencing technique 1B00 as used in conjunction with a co-trained PII classifier. As an option, one or more variations of document content inferencing technique 1B00 or any aspect thereof may be implemented in the context of the architecture and functionality of the embodiments described herein and/or in any in any environment.

The figure is being presented to illustrate how continuously incoming documents that are entered into a content management system 104 can be processed using a continuously co-trained PII classifier so as to determine whether or not a particular portion of a particular incoming document contains PII. As shown, the content management system includes a repository of documents 110, which repository is continuously updated. At any moment in time, and using any known techniques, a particular document can be selected for processing. In accordance with the shown document content inferencing system 160, a selected document 109 is processed within model-based content processor 120. In this embodiment, the model-based content processor divides the contents of the selected document into passages (e.g., text-oriented passages). Such passages can be bounded using any known technique.

Strictly as one example, the selected document might be an email. The email can be bounded into passages that correspond to (1) header information, (2) a greeting, (3) the body of the email, (4) a salutation, and (5) a signature block. Each passage can be evaluated independently and/or various combinations of passages can be amalgamated to form a larger passage. Document content 111 is provided to content classifier 105, which returns outcomes 113. The outcomes can include likelihoods that a passage contains PII. The outcomes can also include indications as to the location in the document where the suspected PII is found within the passage. In some cases, a document passage that is provided to the content classifier is deemed to be free of PII. In other cases, a document passage that is provided to the content classifier is deemed to have some likelihood that the passage contains PII. In such cases where a document passage is deemed to have some likelihood that the passage contains PII, the passage with its corresponding likelihood value 122 is passed to combiner 140 for further processing. Furthermore, in such cases as the latter, any number of suspect PII-containing document content 121 may be delivered to a rule-based processor.

As shown, rule-based content processor 130 accepts any number of suspect PII-containing document content 121 (e.g., received from model-based content processor 120) and processes it in conjunction with PII detection rulebase module 107. In addition to returning a confidence value 132, the application of any particular rule may result in identification of a particular infotype designation (e.g., a phone number, a credit card number, a password, etc.) together with its location (e.g., location of certain document content within a document). Furthermore, any infotype hotwords used by the rule, a confidence value, and/or other information or attributes that can be derived by the rule when applied over the document content can be identified and so designated. This is shown in select sample PII rule results 159. As used herein, an infotype hotword is a representation of a string or marker that is used by an infotype rule to isolate suspected PII.

The combiner 140 can use inputs from both the model-based content processor 120 as well as the rule-based content processor 130 so as to reach a determination as to whether or not a certain portion of content a document contains PII. In some cases combiner 140—in addition to making a determination 142 (e.g., based on likelihood value 122 and confidence value 132) that the certain portion of the content of the document contains PII—the combiner can also use the location of the suspected PII to inform labeling and other downstream processes. In some embodiments, merely the confidence value corresponding to a certain portion of content a document, and a likelihood value corresponding to the same certain portion of content a document, can be used to determine whether or not the certain portion of content contains personally identifiable information.

FIG. 1C shows a document that is subjected an example PII rule to produce PII rule results. The figure is being presented to illustrate how a document can be subjected to PII rules to produce corresponding PII rule results. As shown, the rule results include (1) the fact of occurrence that a particular PII rule actually “hit” so as to actually produce some PII results (e.g., rule hit 181), (2) a set of rule hotwords that were used by the rule (e.g., rule hotwords 182), and (3) an indication of where in the document the rule hit (e.g., rule hit locations 183).

The fact that a particular uniquely-identifiable PII rule actually “hit” (e.g., on a particular infotype), the set of rule hotwords that were used by the rule to cause a hit and the indication of where in the document the rule actually hit (e.g., rule hit locations 183) are provided to the unsupervised classifier co-training module 103 of model generator 102.

In this particular example, the document is an email draft that is organized by line number. The content of the document is prose that appears in several successive paragraphs. A set of PII rules are applied over the contents of the document. When a PII rule (e.g., a regular expression) is found in the document (e.g., a “hit”) then the PII rule is said to have fired. A fired PII rule emits rule results. A rule can be designated to be specific to a particular infotype.

As shown, the string “(123) 456-7890” corresponds to a phone number infotype rule having a regular expression of the form “(nnn) nnn-nnnn”, where n matches any numeral. Further, additional terms of the phone number infotype rule matches the hotwords of the string “phone number”. Also, the string “123 Happy Valley Street” corresponds to a street address infotype rule having a regular expression of the form “n* * Street”, where n matches any numeral, and the “*” character denotes any match. Additional terms of the street address infotype rule matches the hotwords of the string “street address”. In this example, and strictly for illustrative purposes, the locations in the document are designated by line number, however a location in a document can be designated using any known techniques (e.g., using paragraph numbers, offsets, section identifiers, etc.). In addition to the first set of conditionally independent inputs (e.g., rule hits, rule hotwords and rule hit locations), a second set of conditionally independent inputs (e.g., context around the locations where the rule or rules hit) is used to co-train the PII classifier. The context does not include the portions of the pick-up from the rule (e.g., regular expression match strings), nor does the context include the hotwords from the rule. Application of multiple rules over the same document or portions of a document serves to identify rule-specific infotype designations, rule-specific infotype locations, and rule-specific infotype hotwords.

As can now be understood, and in the context of the example of FIG. 1C, the use of conditionally independent sets of inputs for training a PII classifier can result in a PII classifier that is as good as (e.g., in terms of precision and recall) a PII classifier that had been trained over a labeled dataset. The thusly co-trained PII classifier can be used in combination with inferencing techniques. More specifically, the foregoing classifier co-training techniques of FIG. 1A and the foregoing inferencing techniques of FIG. 1B can be combined to implement systems that determine whether or not a particular document contains personally identifiable information. Moreover, the classifier co-training techniques of FIG. 1A (e.g., using two conditionally independent sets of inputs for model training) can be used to label an unlabeled dataset of documents that at least potentially comprise personally identifiable information (PII).

This classifier co-training can be carried out over an unlabeled dataset of documents by (1) assigning a confidence value that the first portion of the document does contain personally identifiable information based on applying a PII rule (e.g., a regular expression rule for isolating a phone number) to a first portion of a document of the unlabeled dataset, and then (2) to avoid overfitting the model, selecting a second portion of the document (e.g., a second portion that does not include the first portion), and using such a conditionally independent portion for training. When a sufficient number of documents are considered, a likelihood value that corresponds to characteristics of the second portion can be used in combination with the confidence value such that the combination serves to indicate whether or not the document contains personally identifiable information. In this example, the occurrence of the word “mobile” in the context around the string that was hit by a rule serves to increase the likelihood that the document, or at least the phone number string and/or its context, contains PII. As such, by combining rule-oriented training with context oriented training when constructing a PII classifier, the problem of false positives that occur when using PII rules alone, as well as the problem of false negatives that occur when using PII rules alone, is solved.

Of course the foregoing example is presented merely for illustration, specifically, to illustrate that the context around the portion of the passage that was hit by a rule might contain additional information that is indicative that the portion that was hit by the rule does indeed contain PII. The context around the portion of the passage that was hit by a rule might include PII and/or PII indicators that are not caught by any rule. Such context might appear before the passage that was hit by a rule (e.g., “my mobile” as shown in line 6 of the example of FIG. 1C), and/or such context might appear after the passage that was hit by a rule (e.g., “I hope this gives you the information you need” as shown in line 11 of the example of FIG. 1C).

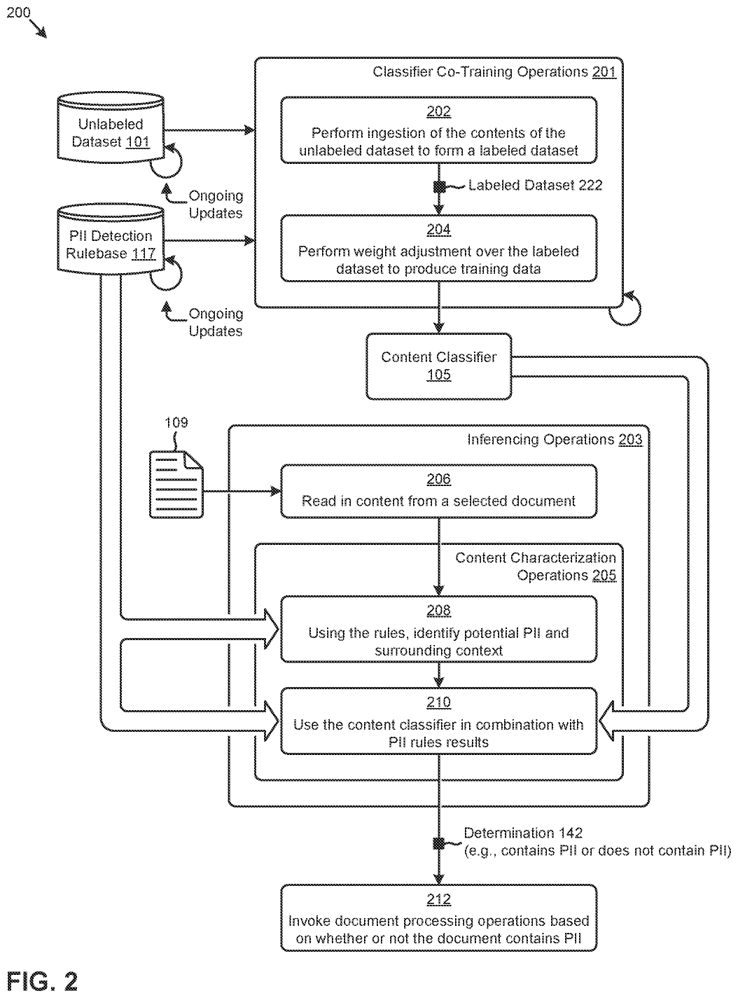

An implementation of the foregoing classifier training system (as in FIG. 1A) and an implementation of a document content inferencing system (as in FIG. 1B) can be combined into a system for determining whether a document contains PII. Such a system is shown and described as pertains to FIG. 2.

FIG. 2 is a dataflow diagram showing a system 200 for determining whether a document contains PII. As an option, one or more variations of system 200 or any aspect thereof may be implemented in the context of the architecture and functionality of the embodiments described herein and/or in any in any environment.

The figure is being presented to show how classifier co-training operations 201 and inferencing operation 203 can be combined into a system that invokes document processing operations based on whether or not a particular document contains PII. Specifically, and as shown, a content classifier 105 is trained by classifier co-training operations 201, such that thereafter, content classifier 105 can be used by the inferencing operations. Results from performance of the inferencing operations include a determination 142 as to whether or not a particular selected document contains PII. Based on the determination 142, the document can be subject to further processing.

In the particular embodiment of FIG. 2, the shown classifier co-training operations 201 implements unsupervised learning through unsupervised labeling of an unlabeled dataset 101 (step 202) to produce labeled dataset 222. Moreover, the shown classifier co-training operations 201 include performing weight adjustment over the labeled dataset (step 204). One result of performance of step 202 and step 204 is the generation of content classifier 105 that is co-trained using conditionally independent inputs that are derived from (1) an unlabeled dataset of documents, and (2) application of one or more rules drawn from a PII detection rulebase 117. The independent inputs can be guaranteed to be conditionally independent using any of the document processing techniques discussed herein. Moreover, the independent inputs can be updated on an ongoing basis. Specifically, and as shown, the unlabeled dataset 101 can be periodically augmented during ongoing updates. Similarly, and as shown, the PII detection rulebase 117 can be periodically augmented during ongoing updates. The classifier co-training operations can be invoked and re-run at any moment in time so as to add additional stimulus signals and response outcomes to the content classifier.

At any moment in time, a selected document 109 may be presented for inferencing. This is shown at step 206 where a selected document 109 is read in. In this embodiment, the act of reading in a document includes determining the occurrence and bounds of any number of portions of the document. Each determined portion can then be subjected to any of a variety of content characterization operations 205. In the example shown, a determined portion can be processed (at step 208) by applying one or more rules from a PII detection rulebase 117. Potential PII and the surrounding context can be processed (e.g., by applying rules) so as to identify the occurrence and bounds of suspected PII (e.g., the string “123-456-7890”) as well as to identify occurrence and bounds of any context appearing ahead of the suspected PII (“my Social Security Number is:”) and any context appearing after of the suspected PII (“so don't share it with anyone”).

Once a portion of a document has been divided up such that the suspected PII can be bounded into a first portion and such that the context around the suspected PII is bounded into a second portion, then step 210 serves to combine a model-based likelihood value that a particular document portion (e.g., passage) contains suspected PII and a rule-based confidence value that the suspected PII is (for example) of a particular infotype designation. At this point in the dataflow, a determination 142 can be made as to whether or not a particular portion of a document, and therefore the document as a whole, contains PII. If the determination is “Yes” then certain document processing operations may be invoked (step 212). Strictly as examples, a particular selected document that includes PII might be subjected to data cleaning (e.g., deletion of the PII) and/or to data obfuscation (e.g., replacing 123-456-7890 with XXX-XXX-XXXX) and/or to labeling the document as containing PII and/or labeling the document with security tags, etc.

As still further examples of downstream processing after making a determination that a document contains PII, the determination might be used for (1) informing a rate limiter component that can be configured to prevent users from excessive downloading of PII-containing documents (e.g., a number of documents over a threshold), (2) informing a threat detection system that deems certain user behavior as risky user behavior (e.g. if user behavior suddenly or unexpectedly shifts toward accessing PII-containing documents, (3) informing a folder classification system that can classify a folder with a “sensitive” label (e.g., if the folder contains many PII-containing documents), and/or for (4) informing a user classification system that identifies and/or labels users with a user sensitivity value corresponding to a count of generated/uploaded PII-containing documents.

Still further, a particular PII designation (e.g. PII_type=“social security number”) can be added to the metadata for the document, which in turn can be used to inform parameterized searches (e.g., “find all documents that mention ‘John Doe’ and that have an occurrence of PII of type ‘social security number’”).

Additionally or alternatively, statistics over a given corpus of documents can be computed based on the occurrence and type of PII found in the documents of the corpus (e.g. 60% of the documents in this folder have PII of type “credit card number” in them). Such statistics can in turn be used to initiate and/or inform additional downstream actions (e.g. downstream file and/or folder labeling based on the occurrence and type of PII found in the documents).

Additionally or alternatively, a particular selected document that includes PII might be subject to assignment of a retention policy (e.g., to store more securely, or to keep for a longer period, or prevent sharing or other transmission of the selected document outside of a particular geography or jurisdictional boundary, etc.).

Additionally or alternatively, a particular selected document that includes PII might be indexed in a manner that facilitates fast (e.g., indexed) retrieval of specific PII pertaining to a particular user. It is possible to index all documents that contain PII for a particular individual, and as such, it would be possible to perform PII-related actions on all documents that contain PII for a particular individual, and/or it would be possible to perform PII-related actions on all documents that contain a particular type of PII (e.g., a social security number). Strictly as an example, a particular individual might request that all documents that contain his or her PII be expunged or redacted. Metrics that derive from this sort of indexing can be applied to the corpora of documents, and thereby collect and aggregate statistics. As examples, such statistics might answer non-PII questions pertaining to “How many files include user PII?”, or “Who has most PII by file count?”, or “What percentage of files are deemed to contain PII?”, etc. Moreover such derived statistics can facilitate detection of malware or ransomware by identifying and labeling users who are reading and modifying PII. Additionally or alternatively, the statistics can be used select and apply rules. For example, a labeling rule might be codified as, “IF <user> has a <threshold> amount of PII updates to files, THEN update likelihood that <user> deals with sensitive data”. As another example, a labeling rule might be codified as, “IF <folder> has <threshold percentage of files with PII> THEN mark the folder and all of the folder's contents as <sensitive>.

Additionally or alternatively, the statistics can inform rate limiters so as to govern (e.g., limit or prevent) a rate of downloading. This can give administrators more time to assess a potential data loss breach.

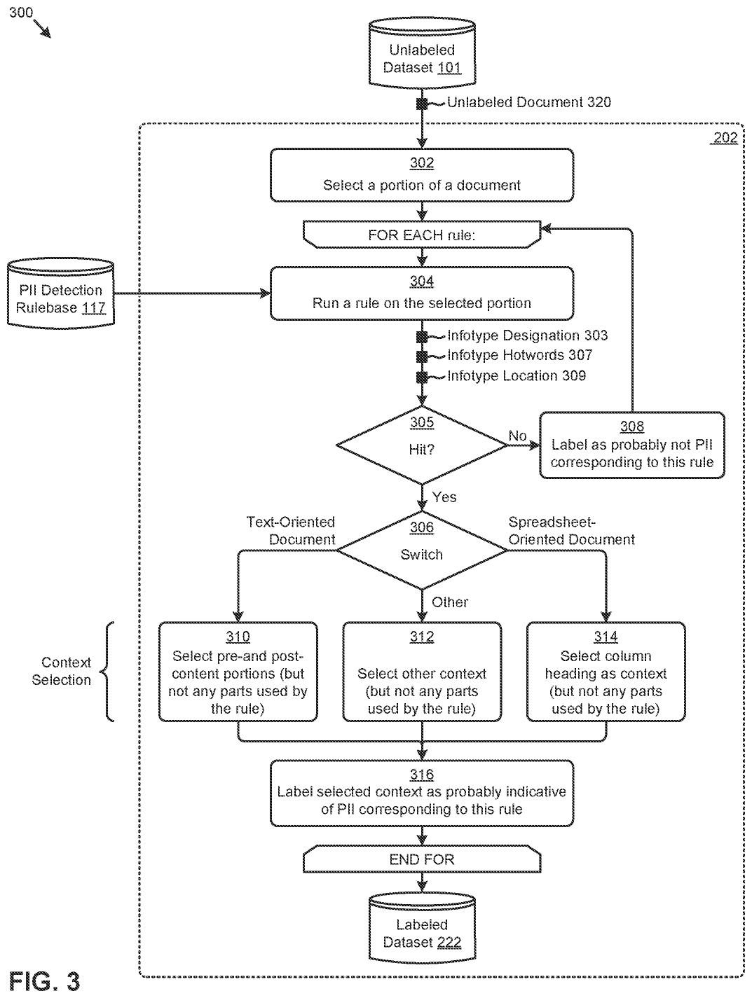

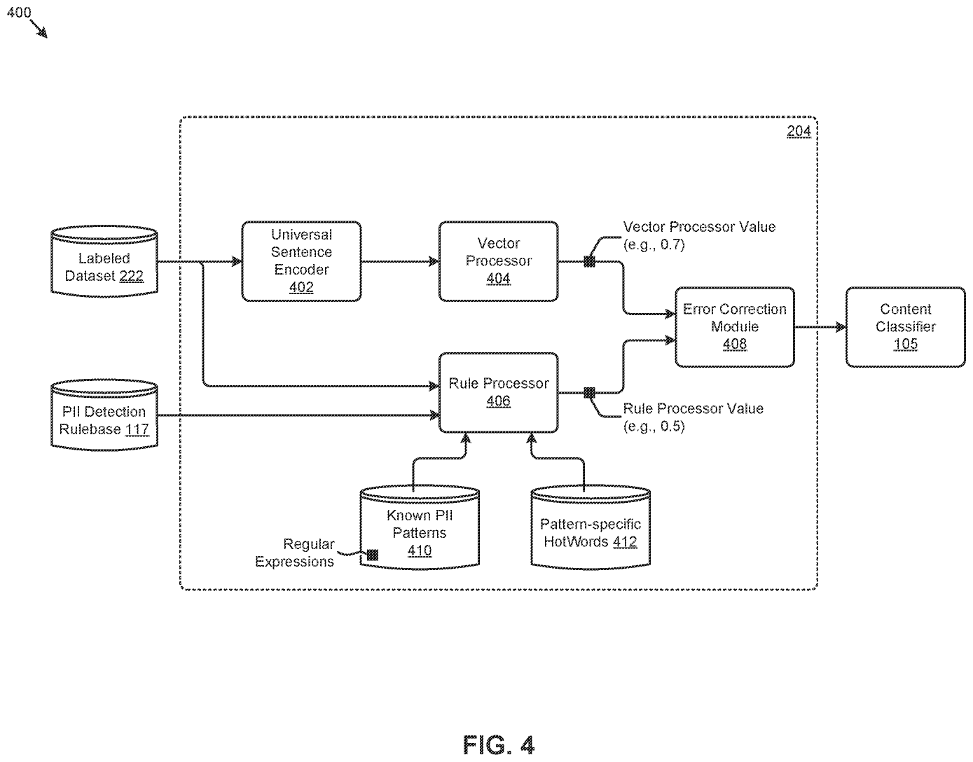

The foregoing discussion of FIG. 2, specifically the discussion of the classifier co-training operations 201 included mention of step 202 referring to techniques for ingesting an unlabeled dataset to produce a labeled dataset, and step 204 referring to techniques for performing weight adjustment over the labeled dataset. Details of these two techniques are shown and described as pertains to FIG. 3 and FIG. 4.

FIG. 3 is a dataflow diagram showing an unsupervised training data ingestion technique 300 as used in systems that improve classifier precision and recall by using conditionally independent input signals. As an option, one or more variations of unsupervised training data ingestion technique 300 or any aspect thereof may be implemented in the context of the architecture and functionality of the embodiments described herein and/or in any in any environment.

The figure is being presented to illustrate one implementation of a technique for ingesting an unlabeled dataset 101 to produce a labeled dataset 222. The technique is an implementation of unsupervised labeling. The unsupervised labeling exploits the conditional independence between two portions of a document. Specifically, a first portion being that portion of document content that corresponds to a rule (e.g., hit strings, hot words, etc.), and a second portion being certain portions of the document that do not overlap the first portion.

The conditionally independent portions, both portions of which become input signals for training the classification model, can be used for labeling an unlabeled dataset. As shown, this embodiment takes in an unlabeled dataset 101 comprising at least one unlabeled document 320, then selects a portion (step 302) of that document, before proceeding into a FOREACH loop that applies one or more PII detection rules from PII detection rulebase 117 over the selected portion (step 304).

Performance of step 304 over any particular rule can yield multiple rule results. As examples, and as shown, rule results might include an infotype designation 303, an indication of infotype hotwords 307 used during application of the rule, an infotype location 309, etc.

If decision 305 determines that the rule did not hit, then the “No” branch of decision 305 is taken, and the selected portion is labeled (step 308) as probably not PII corresponding to the particular rule. On the other hand, if there is a hit at decision 305 (e.g., where a particular rule yields sufficiently high confidence of an infotype designation), then the “Yes” branch of decision 305 is taken. Then, based on switch 306, context around the location of the infotype (but not including the infotype itself and not including infotype hotwords 307) is selected. The selected context is then labeled (step 316) with an indication that the selected portion (or similar content) probably contains PII corresponding to the infotype of the rule. The selected portion itself can be similarly labeled. Once a particular rule has been processed in the FOREACH loop, the loop iterates over the next rule. In cases when a rule does not yield any results, or in cases when a rule does not yield a sufficiently high confidence of a particular infotype designation, the “No” branch of decision 305 is taken, and step 308 serves to label the selected portion as probably not PII corresponding to the particular rule.

In some embodiments, a single passage or other portion of a document may be subjected to application of a plurality of rules, and as such, such a single passage or other portion of a document may be associated with a plurality of indications that the passage or other portion probably contains PII of an infotype corresponding to the rule. In embodiments that include an implementation such as is shown in FIG. 3, an association that a passage or other portion of a document probably contains PII of a particular infotype corresponding to the rule can be codified as a label or labels that are attached to the infotype and/or to the context and/or to the passage or other portion of the document itself.

The aforementioned embodiment includes selecting a passage or other portion (step 302) from an unlabeled document 320. The boundary of the passage or other portion can be defined using any known technique. Strictly as examples, the location and contours (e.g., beginning, end) of a passage or other portion can be defined by the location and length of a sentence or paragraph or section of a document. Alternatively, the location and contours (e.g., beginning, end) of a passage or other portion can be defined by a starting word and a number of words that precede or follow. Some documents are structured as forms, and as such, the location and contour of a passage or other portion can be defined by contents of form fields, and/or their juxtaposition to form field widgets, and/or the title of the field, etc.

The boundary or boundaries as heretofore-described can be used to inform the method for context selection and labeling. Strictly as examples, it can happen that a particular passage contains multiple infotypes (e.g., the passage contains both a home phone number and a mobile phone number) at multiple infotype locations. In some cases, the outputs arising from application of a rule is used to inform the method for context selection and labeling. Specifically, if decision 305 determines that there was a hit, then processing proceeds to switch 306 that directs processing to invoke one of several possible context selections techniques. Strictly to illustrate the shown embodiment, one particular technique (of step 310) is invoked when a passage is selected from a text-oriented document. Another particular technique (of step 314) is invoked when selected content is taken from a spreadsheet-oriented document, and potentially, yet a different particular technique (of step 312) is applied to some other type of document. As such, the nature of the document, and/or any determination of the boundary or boundaries of any particular document content, and/or any of the outputs arising from application of a rule, can be used to inform the method for context selection (step 316) and labeling.

Once the selected context has been bounded by any one or more of the foregoing context selection techniques, the selected context can be labeled (step 316) as being probably indicative of PII corresponding to the particular rule of that particular iteration. When the iterator completes, the formerly unlabeled dataset 101 now has a corresponding labeled dataset 222.

Returning again to the discussion of the classifier co-training operations of FIG.2, step 202 and step 204 cooperate to generate a weight adjusted labeled dataset. One technique for weight adjustment is shown and described as pertains to the dataflow diagram of FIG. 4.

FIG. 4 is a dataflow diagram showing a weight adjustment technique 400 using back propagation to improve PII classifier precision and recall by using conditionally independent input signals. As an option, one or more variations of weight adjustment technique 400 or any aspect thereof may be implemented in the context of the architecture and functionality of the embodiments described herein and/or in any in any environment.

The figure depicts one possible implementation of step 204 (FIG. 2). This implementation takes as inputs (1) a labeled dataset 222 and (2) a PII detection rulebase 117, and produces adjusted weights (e.g., weight type1 and weight type2). The error correction module 408 receives two incoming values from two conditionally-independent sets of inputs (e.g., the vector processor value and the rule processor value, as shown), compares them to an error calculation, and then adjusts the weights to reduce the error. The weight adjustment method could be a gradient descent algorithm employing, for example, one or more of several back-propagation methods. In one example implementation of back-propagation, the vector processor 404 is a feed forward deep neural network and adjustments are computed by (1) differentiating the loss function for each input in each layer of the network, and (2) iteratively choosing a weight adjustment that would reduce the error by a precalculated maximum amount and then (3) applying the adjustment. The iterations are repeated until the overall error (e.g., as measured by a loss function) reaches an acceptable value, and/or when no more weight adjustment improvements are possible. In this specific example, the back-propagation algorithm analyzes labels that are generated by the rule based module 117, which can potentially produce noisy label outputs. However, due to the mathematic lemmas that arise as a result of choosing two conditionally independent sets of inputs, back-propagation will converge, resulting in a classifier that is as good (e.g., in terms of precision and recall) as a classifier that had been trained on non-noisy (e.g., perfectly accurate) labels.

In the specific example shown, a first set of independent inputs derives from vector encoding (e.g., via universal sentence encoder 402) and vector processing (e.g., via vector processor 404). A second set of independent inputs derives from rule processing (e.g., via rule processor 406). As shown, such rule processing includes application of known PII patterns 410 (e.g., codified as “regex” style regular expressions) in combination with pattern-specific hotwords 412.

The results of processing these two conditionally independent sets of inputs through the shown flow results in vector weightings such that the content classifier 105 exhibits precision and recall that is improved as compared with unweighted vectors.

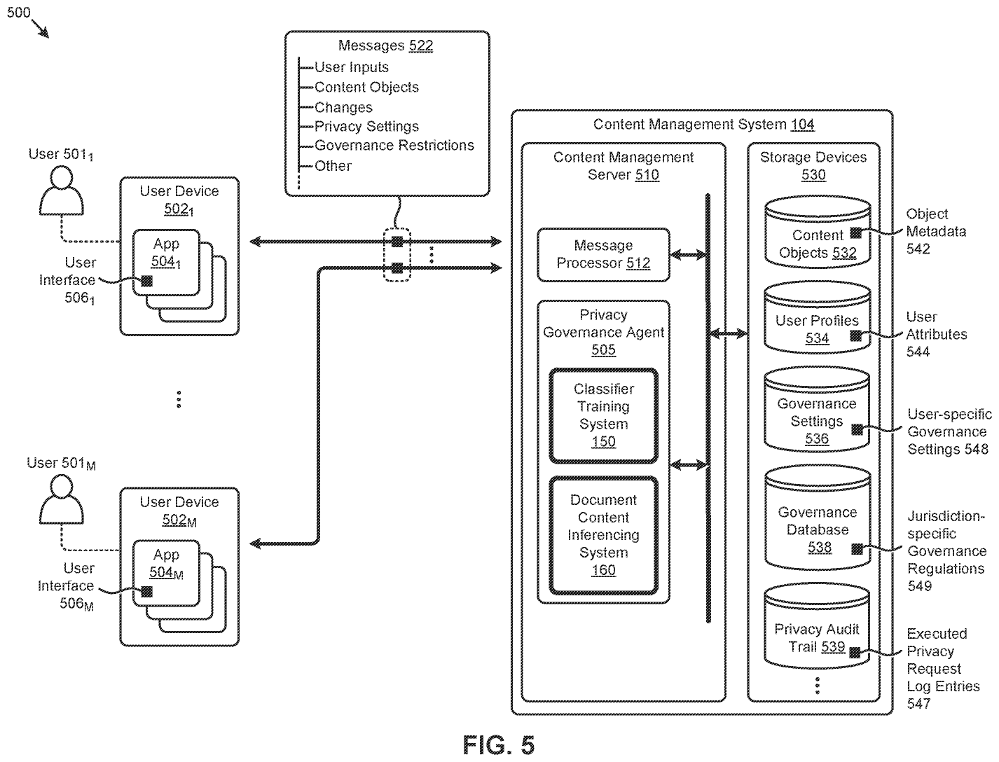

FIG. 5 shows an example content management system environment 500 in which aspects of a PII classifier and a PII inferencer can be implemented. As an option, one or more variations of content management system environment 500 or any aspect thereof may be implemented in the context of the architecture and functionality of the embodiments described herein and/or in any in any alternative environments.

The figure is being presented to illustrate how a classifier training system 150 and a document content inferencing system 160 can be used to facilitate handling of user documents that contain PII. More specifically, the figure is being presented to illustrate how a classifier training system 150 and a document content inferencing system 160 can be used to process any documents of a content management system 104 so as to comply with any of a variety of user-raised privacy requests and/or to comply with any of a variety of governance considerations.

As shown, the example content management system environment 500 includes multiple users (e.g., user 501₁, . . . user 501_{M}) who operate respective user devices (e.g., user device 502₁, . . . user device 502_{M}) via user interfaces (e.g., user interface 506₁, . . . user interface 506_{M}) that correspond to applications or apps (e.g., app 504₁, . . . app 504_{M}) running on the user devices.

A user device communicates with the content management system via messages 522, which messages can originate from a user device or from the content management system. This facilitates many use models for processing user-raised privacy requests and/or use models that seek to maintain compliance with any of a variety of governance considerations. Strictly to illustrate one possible implementation of a system for processing user-raised privacy requests while maintaining compliance with any of a variety of governance considerations, the shown content management system 104 includes a privacy governance agent 505 that is situated in a content management server 510. The content management server communicates with any number of storage devices 530, which storage devices may be arranged in any manner that facilitates access to data by processing elements of the content management server.

In one set of use cases, a user device raises one or more message 522 that codify user inputs (e.g., user-initiated requests, user-initiated privacy settings, user-indicated content objects, etc.). Operational elements of the content management system 104 (e.g., message processor 512) receives such user inputs as messages 522 and routes the messages to other operational elements.

To illustrate through an example, a user might request “Obfuscate or obliterate all occurrences of my social security number in any/all documents”. In response to the user-initiated request, the privacy governance agent 505 might access user profiles 534 to identify any user attributes 544 that might be useful in determining the scope of what documents might need to be considered for the possibility that the documents do contain the user's social security number. Additionally or alternatively, in response to the user-initiated request, the privacy governance agent 505 might access any one or more of the content objects 532 to identify any object metadata 542 (e.g., collaboration or sharing entries) that might be useful in determining the scope of which documents might need to be considered for the possibility that the documents do contain the user's social security number.

Once the scope of documents to be considered for the possibility that the documents do contain the user's social security number has been determined, then the privacy governance agent 505 can iterate through content taken from the set of such documents, where individual portions of the content are individually considered by the document content inferencing system 160. In the event that a particular individual portion of the content is labeled as containing a PII infotype corresponding to a social security number, then that particular individual portion or sub-portion thereof (e.g., at the infotype location) can be obliterated or obfuscated. The actions taken (e.g., to obliterate or to obfuscate the occurrence or occurrences of the PII infotype) can be logged as executed privacy request log entries 547, possibly as entries in a privacy audit trail 539. In some cases, a user-initiated request may include standing instructions (e.g., possibly as codified in privacy settings). In such cases, the standing instructions can be entered into governance settings 536 in the form of a user-specific governance setting 548.

The example content management system environment 500 supports other use models that are specific to maintaining compliance with a wide range of jurisdiction-specific governance regulations 549. Such jurisdiction-specific governance regulations can be codified into computer-processable representations and stored in a governance database 538. In certain circumstances, a particular user device might be subject to jurisdiction-specific governance regulations. Moreover, the particular user device might be subject to different jurisdiction-specific governance regulations as the user device becomes logged-in from different geographies. In such cases, the user device might be subjected to governance restrictions (e.g., jurisdiction-specific restrictions) pertaining to communication of personally identifiable information and/or pertaining to other communications. Strictly as one example, when a user device is logged in from a geography that corresponds to an international trafficking in arms regulations (ITAR) country, the governance restrictions might prohibit communications that pertain to any document that contains any type of PII.

The example content management system environment 500 supports other use models that are specific to maintaining any number of governance databases. Strictly as an example, there may be continuously changing governance restrictions pertaining to communications to/from user devices and/or pertaining to handling of any document that contains any type of PII. In one possible embodiment, an administrator (e.g., user 501_{M}) might direct one or more messages 522 comprising changes (e.g., governance regulation changes) to the content management system's message processor. The content management system in turn might make corresponding changes or additions to the governance database. In some cases, the occurrence of such a change might trigger an iteration through content objects 532 to determine whether or not a particular document or portion thereof needs to be labeled or otherwise processed.

Further details regarding general approaches to determining if a particular document or portion thereof needs to be labeled or otherwise processed are described in U.S. application Ser. No. 17/163,222, titled “PRIORITIZING OPERATIONS OVER CONTENT OBJECTS OF A CONTENT MANAGEMENT SYSTEM” filed on Jan. 29, 2021, which is hereby incorporated by reference in its entirety.

### Additional Embodiments of the Disclosure

### Instruction Code Examples

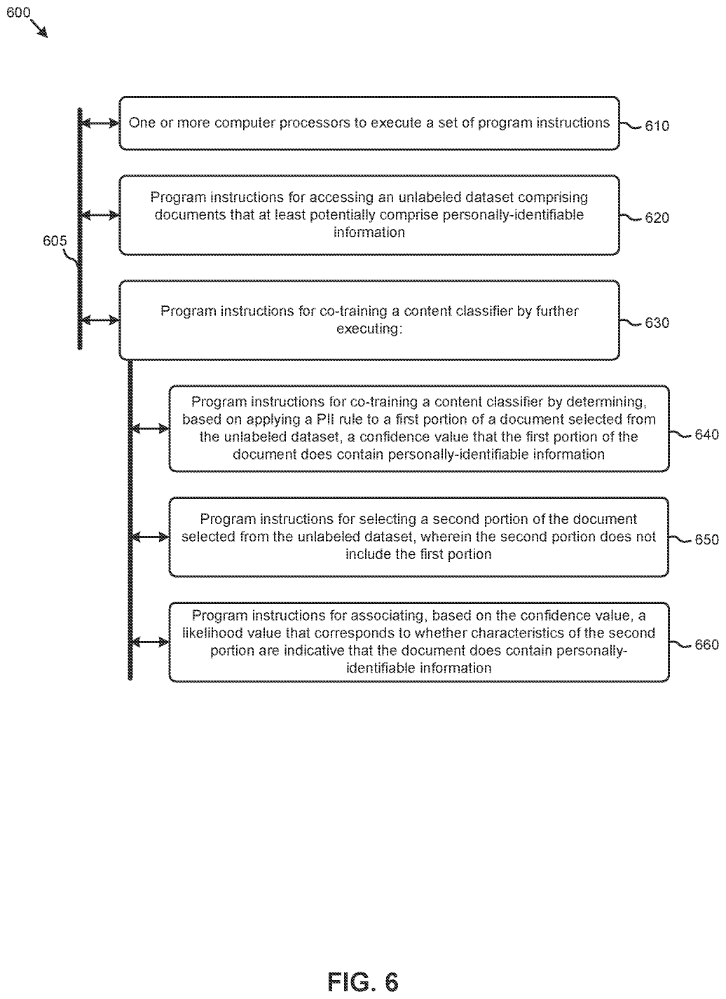

FIG. 6 depicts a system 600 as an arrangement of computing modules that are interconnected so as to operate cooperatively to implement certain of the herein-disclosed embodiments. This and other embodiments present particular arrangements of elements that, individually or as combined, serve to form improved technological processes that address improving precision and recall of a PII classifier. The partitioning of system 600 is merely illustrative and other partitions are possible. As an option, the system 600 may be implemented in the context of the architecture and functionality of the embodiments described herein. Of course, however, the system 600 or any operation therein may be carried out in any desired environment. The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with any other operations over communication path 605. The modules of the system can, individually or in combination, perform method operations within system 600. Any operations performed within system 600 may be performed in any order unless as may be specified in the claims. The shown embodiment implements a portion of a computer system, presented as system 600, comprising one or more computer processors to execute a set of program code instructions (module 610) and modules for accessing memory to hold program code instructions to perform: accessing an unlabeled dataset comprising documents that at least potentially comprise personally identifiable information (module 620); and co-training a content classifier (module 630) by further executing program instructions for determining, based on applying a PII rule to a first portion of a document selected from the unlabeled dataset, a confidence value that the first portion of the document does contain personally identifiable information (module 640); selecting a second portion of the document selected from the unlabeled dataset, wherein the second portion does not include the first portion (module 650); and associating with the second portion, based on the confidence value, a likelihood value that corresponds to whether characteristics of the second portion are indicative that the document does contain personally identifiable information (module 660).

Variations of the foregoing may include more or fewer of the shown modules. Certain variations may perform more or fewer (or different) steps and/or certain variations may use data elements in more, or in fewer, or in different operations.

### System Architecture Overview

### Additional System Architecture Examples

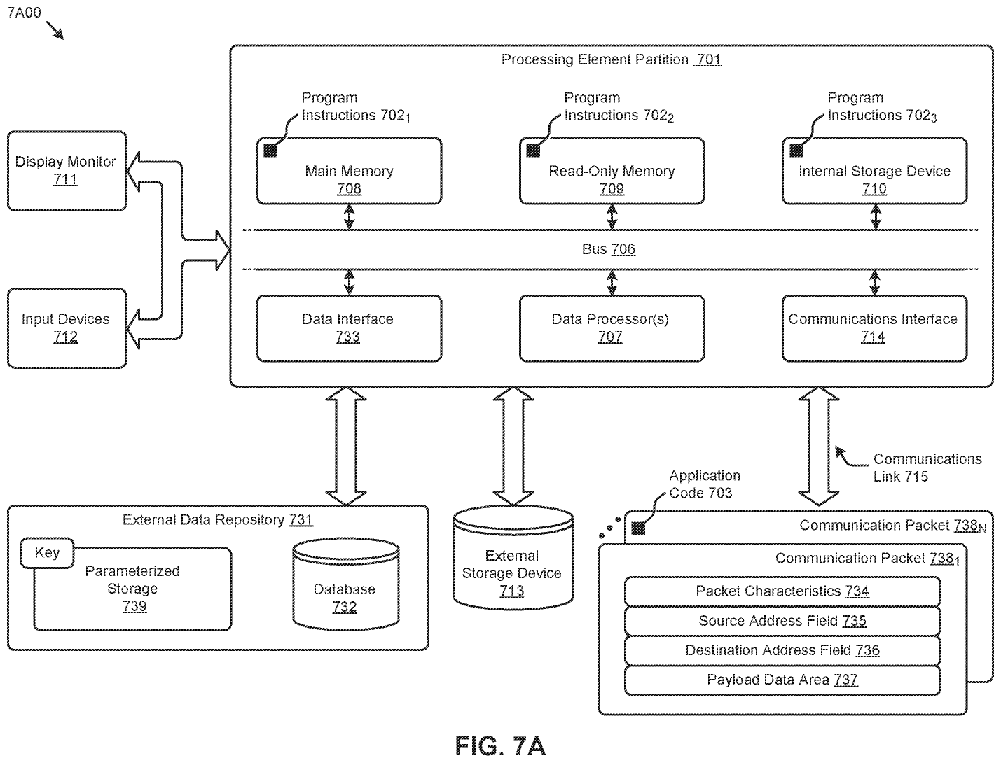

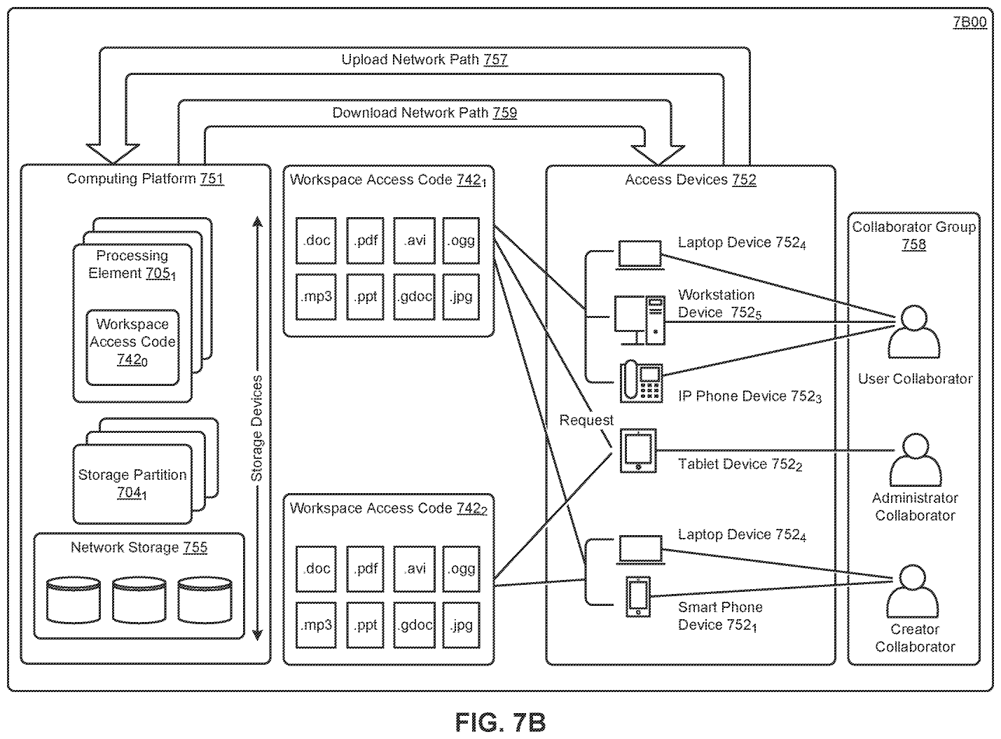

FIG. 7A depicts a block diagram of an instance of a computer system 7A00 suitable for implementing embodiments of the present disclosure. Computer system 7A00 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 7A00 further comprises a display 711 (e.g., CRT or LCD), various input devices 712 (e.g., keyboard, cursor control), and an external data repository 731.

According to an embodiment of the disclosure, computer system 7A00 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 7A00 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of a computer system 7A00. According to certain embodiments of the disclosure, two or more instances of computer system 7A00 coupled by a communications link 715 (e.g., LAN, public switched telephone network, or wireless network) may perform the sequence of instructions required to practice embodiments of the disclosure using two or more instances of components of computer system 7A00.

Computer system 7A00 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 7A00 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to improving classifier precision and recall using conditionally independent input signals. A module may include one or more state machines and/or combinational logic used to implement or facilitate the operational and/or performance characteristics pertaining to improving classifier precision and recall using conditionally independent input signals.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of improving classifier precision and recall using conditionally independent input signals). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to improving classifier precision and recall using conditionally independent input signals, and/or for improving the way data is manipulated when performing computerized operations pertaining to co-training a classifier using selected conditionally independent sets of input signals.

FIG. 7B depicts a block diagram of an instance of a cloud-based environment 7B00. Such a cloud-based environment supports access to workspaces through the execution of workspace access code (e.g., workspace access code 742₀, workspace access code 742₁, and workspace access code 742₂). Workspace access code can be executed on any of access devices 752 (e.g., laptop device 752₄, workstation device 752₅, IP phone device 752₃, tablet device 752₂, smart phone device 752₁, etc.), and can be configured to access any type of object. Strictly as examples, such objects can be folders or directories or can be files of any filetype. The files or folders or directories can be organized into any hierarchy. Any type of object can comprise or be associated with access permissions. The access permissions in turn may correspond to different actions to be taken over the object. Strictly as one example, a first permission (e.g., PREVIEW_ONLY) may be associated with a first action (e.g., preview), while a second permission (e.g., READ) may be associated with a second action (e.g., download), etc. Furthermore, permissions may be associated to any particular user or any particular group of users.

A group of users can form a collaborator group 758, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 751, including in a middleware setting. As shown, a portion of the workspace access code resides in and can be executed on one or more processing elements (e.g., processing element 705₁). The workspace access code can interface with storage devices such as networked storage 755. Storage of workspaces and/or any constituent files or objects, and/or any other code or scripts or data can be stored in any one or more storage partitions (e.g., storage partition 704₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 757). A stored workspace can be delivered to a particular user and/or shared with other particular users via a download (e.g., a download from a processing element to an access device over a download network path 759).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
accessing an unlabeled dataset comprising documents that at least potentially comprise personally identifiable information (PII); and
training a content classifier by:
determining, based on applying a PII rule to a first portion of a document selected from the unlabeled dataset, a confidence value that the first portion of the document does contain personally identifiable information;
selecting a second portion of the document selected from the unlabeled dataset, wherein the second portion does not include the first portion; and
associating with the second portion, based on the confidence value, a likelihood value that corresponds to whether characteristics of the second portion are indicative that the document does contain personally identifiable information.

2. The method of claim 1, further comprising:
identifying a selected portion of a subject content object and applying the selected portion to the content classifier to determine whether characteristics of the selected portion are indicative that the document does contain PII.

3. The method of claim 2, further comprising:
communicating a message to a user device, wherein the message comprises at least a portion of one or more governance restrictions pertaining to communication of personally identifiable information.

4. The method of claim 1, wherein application of the PII rule to the first portion of the document is used to identify at least one of, one or more infotype designations, one or more infotype locations, or one or more infotype hotwords.

5. The method of claim 4, wherein the second portion of the document selected from the unlabeled dataset does not contain any occurrence of the one or more infotype hotwords.

6. The method of claim 1, further comprising:
adjusting a weight of either the likelihood value or the confidence value based on a gradient descent algorithm.

7. The method of claim 1, further comprising:
adjusting a weight of either the likelihood value or the confidence value based on an error calculation that compares a vector processor value to a rule processor value.

8. A non-transitory computer readable medium having stored thereon a sequence of instructions which, when stored in memory and executed by one or more processors causes the one or more processors to perform a set of acts, the set of acts comprising:
accessing an unlabeled dataset comprising documents that at least potentially comprise personally identifiable information (PII); and
training a content classifier by:
determining, based on applying a PII rule to a first portion of a document selected from the unlabeled dataset, a confidence value that the first portion of the document does contain personally identifiable information;
selecting a second portion of the document selected from the unlabeled dataset, wherein the second portion does not include the first portion; and
associating with the second portion, based on the confidence value, a likelihood value that corresponds to whether characteristics of the second portion are indicative that the document does contain personally identifiable information.

9. The non-transitory computer readable medium of claim 8, further comprising instructions which, when stored in memory and executed by the one or more processors causes the one or more processors to perform acts of:
identifying a selected portion of a subject content object and applying the selected portion to the content classifier to determine whether characteristics of the selected portion are indicative that the document does contain PII.

10. The non-transitory computer readable medium of claim 9, further comprising instructions which, when stored in memory and executed by the one or more processors causes the one or more processors to perform acts of:
communicating a message to a user device, wherein the message comprises at least a portion of one or more governance restrictions pertaining to communication of personally identifiable information.

11. The non-transitory computer readable medium of claim 8, wherein application of the PII rule to the first portion of the document is used to identify at least one of, one or more infotype designations, one or more infotype locations, or one or more infotype hotwords.

12. The non-transitory computer readable medium of claim 11, wherein the second portion of the document selected from the unlabeled dataset does not contain any occurrence of the one or more infotype hotwords.

13. The non-transitory computer readable medium of claim 8, further comprising instructions which, when stored in memory and executed by the one or more processors causes the one or more processors to perform acts of:
adjusting a weight of either the likelihood value or the confidence value based on a gradient descent algorithm.

14. The non-transitory computer readable medium of claim 8, further comprising instructions which, when stored in memory and executed by the one or more processors causes the one or more processors to perform acts of:
adjusting a weight of either the likelihood value or the confidence value based on an error calculation that compares a vector processor value to a rule processor value.

15. A system comprising:
a storage medium having stored thereon a sequence of instructions; and
one or more processors that execute the sequence of instructions to cause the one or more processors to perform a set of acts, the set of acts comprising,
accessing an unlabeled dataset comprising documents that at least potentially comprise personally identifiable information (PII); and
training a content classifier by:
determining, based on applying a PII rule to a first portion of a document selected from the unlabeled dataset, a confidence value that the first portion of the document does contain personally identifiable information;
selecting a second portion of the document selected from the unlabeled dataset, wherein the second portion does not include the first portion; and
associating with the second portion, based on the confidence value, a likelihood value that corresponds to whether characteristics of the second portion are indicative that the document does contain personally identifiable information.

16. The system of claim 15, further comprising:
identifying a selected portion of a subject content object and applying the selected portion to the content classifier to determine whether characteristics of the selected portion are indicative that the document does contain PII.

17. The system of claim 16, further comprising:
communicating a message to a user device, wherein the message comprises at least a portion of one or more governance restrictions pertaining to communication of personally identifiable information.

18. The system of claim 15, wherein application of the PII rule to the first portion of the document is used to identify at least one of, one or more infotype designations, one or more infotype locations, or one or more infotype hotwords.

19. The system of claim 18, wherein the second portion of the document selected from the unlabeled dataset does not contain any occurrence of the one or more infotype hotwords.

20. The system of claim 15, further comprising:
adjusting a weight of either the likelihood value or the confidence value based on a gradient descent algorithm.
